(19) United States
(12) Patent Application Publication
(10) Pub. No.: US 2015/0347047 A1
(43) Pub. Date: Dec. 3, 2015

(54) MULTILAYERED DATA STORAGE METHODS AND APPARATUS

(71) Applicant: Coraid, Inc., Santa Clara, CA (US)

(72) Inventors: Cahya Adiansyah Masputra, San Jose, CA (US); Nakul Pratap Saraiya, Palo Alto, CA (US); Richard Michael Elling, Ramona, CA (US); Prashanth K. Sreenivasa, Milpitas, CA (US); Donald James Brady, Woodland Park, CO (US); Michael Pierre Mattsson, Redwood City, CA (US)

(21) Appl. No.: 14/687,336

(22) Filed: Apr. 15, 2015

Related U.S. Application Data
(60) Provisional application No. 62/007,191, filed on Jun. 3, 2014.

(51) Int. Cl. G06F 3/06

(52) U.S. Cl. CPC G06F 3/0619; G06F 3/0689; G06F 3/0665

(57) ABSTRACT

A system, method, and apparatus for providing multilayered storage are disclosed. An example apparatus includes a virtual storage node and a data services node. The virtual storage node includes a first physical storage device including a first storage pool configured to have a first storage configuration and partitioned into individually addressable logical unit numbers (“LUs”) and a second storage pool configured to have a second storage configuration and partitioned into individually addressable LUs. The data services node includes a service pool configured to have a data services configuration specifying how data is stored to a logical volume from the virtual storage node, the logical volume including at least a first set of LUs from the first storage pool and second of LUs from the second storage pool.

### PRIORITY CLAIM

The present application claims priority to and the benefit of U.S. Provisional Patent Application No. 62/007,191, filed on Jun. 3, 2014, the entirety of which is incorporated herein by reference.

### BACKGROUND

Currently, many pay-as-you-grow cloud service providers and enterprises use single layer file systems, such as block storage systems, block and file storage systems, and high-performance file systems. Oftentimes, the single layer file systems use Layer-2 Ethernet connectivity for security and performance. The cloud service providers and enterprises generally implement single layer file systems using multiple storage silos configured for multiple workloads such that each storage silo is configured for a different storage configuration. For instance, a first storage silo may be configured in a stripe redundant array of independent disks (“RAID”) 10 level while a second storage silo is configured in a mirror RAID 2 level. The different storage configurations enable the cloud service provider to provide different storage configurations based on the requirements or desires of subscribing clients. The different storage configurations enable an enterprise to select the appropriate storage configuration based on requirements or needs for data storage.

Generally, today's cloud service providers and enterprises assign a storage configuration to one or more storage system chassis. Typically, each storage device or server within the chassis is assigned a unique rung number or identifier. Thus, each of the storage silos (or a management server of the storage silos) includes a list or data structure of the unique rung numbers or identifiers that are configured with the respective storage configuration. Under this single layer configuration, each storage silo is assigned one or more chassis having storage devices that are specifically configured for that storage silo. While this configuration is acceptable under some circumstances, the single layer system provides little scalability and/or flexibility. For example, adding new storage devices to a storage silo requires physically configuring a new chassis or portions of the current chassis and readdressing or renumbering the rung numbers or identifiers. Further, migrating data and the underlying storage configuration to another chassis requires updating the data structure with the identifiers or rung numbers of the storage devices on the new chassis. In another scenario, the readdressing of storage devices within a chassis may result in downtime, lost data, overwritten data, or the reduction in scalability and reactivity based on client usage.

### BRIEF DESCRIPTION OF THE FIGURES

FIG. 1 shows a diagram of a multilayered file system environment, according to an example embodiment of the present disclosure.

FIG. 2 shows a diagram of logical connections between a data services node and virtual storage nodes of the multilayered file system of FIG. 1, according to an example embodiment of the present disclosure.

FIG. 3 shows a diagram of an example virtual storage node, according to an example embodiment of the present disclosure.

FIG. 4 shows a diagram of an example data services node, according to an example embodiment of the present disclosure.

FIG. 5 illustrates a flow diagram showing an example procedure to provision a virtual storage node, according to an example embodiment of the present disclosure.

FIG. 6 illustrates a flow diagram showing an example procedure to provision a data services node, according to an example embodiment of the present disclosure.

FIG. 7 shows a diagram of an example procedure to redistribute a logical unit among physical storage pools within the virtual storage node of FIGS. 1 to 3, according to an example embodiment of the present disclosure.

FIG. 8 shows a diagram of an example procedure to re-silver or re-allocate logical units among physical storage pools within the VSN of FIGS. 1 to 3, according to an example embodiment of the present disclosure.

FIG. 9 shows a diagram of an example two-tier architecture for the VSN 104 of FIGS. 1 to 3, 7, and 8, according to an example embodiment of the present disclosure.

FIG. 10 shows a diagram of a known single tier ZFS architecture.

### DETAILED DESCRIPTION

The present disclosure relates in general to a method, apparatus, and system for providing multilayered storage and, in particular, to a method, apparatus, and system that use at least a two layer storage structure that leverages Layer-2 Ethernet for connectivity and addressing. The example method, apparatus, and system disclosed herein address at least some of the issues discussed above in the Background section regarding single layer file systems by using a virtualized multilayer file system that enables chassis and storage device addresses to be decoupled from the storage service. In particular, the example method, apparatus, and system disclosed herein create one or more virtual storage nodes (“VSNs”) at a first layer and one or more data services nodes (“DSNs”) at a second layer. The DSNs and VSNs are provisioned in conjunction with each other to provide at least a two-layer file system that enables additional physical storage devices or drives to be added or storage to be migrated without renumbering or readdressing the chassis or physical devices/drives.

As disclosed below in more detail, DSNs are files, blocks, etc. that are partitioned into pools (e.g., service pools) of shared configurations (i.e., DSN service configurations). Each service pool has a DSN service configuration that specifies how data is stored within (and/or among) one or more logical volumes of the VSNs. The DSNs include a file system and volume manager to provide client access to data stored at the VSNs while hiding the existence of the VSNs and the associated logical volumes. Instead, the DSNs provide clients data access that appears similar to single layer file systems.

VSNs are virtualized storage networks that are backed or hosted by physical data storage devices and/or drives. Each VSN includes one or more storage pools that are partitioned into slices (e.g., logical units (“LUs”) or logical unit numbers (“LUNs”)) that serve as the logical volumes at the DSN. The storage pools are each provisioned based on a storage configuration, which specifies how data is to be stored on at least a portion of the hosting physical storage device. Generally, each storage pool within a VSN is assigned an identifier (e.g., a shelf identifier), with each LU being individually addressable. A logical volume is assigned to a DSN by designating or otherwise assigning the shelf identifier of the storage pool and one or more underlying LUs to a particular service pool within the DSN.

This two layer configuration accordingly decouples the shelf identifier and LU from a physical chassis, physical storage device, and/or physical storage pool because the addressing is virtualized based on the configuration of the service pools of the DSN and the storage pools of the VSN. The LU within the VSN is accordingly a virtual representation of the underlying assigned or provisioned portion of a physical chassis, physical storage device, and/or physical storage pool. Decoupling the addressing from physical devices enables additional physical storage devices to be added without readdressing, thereby enabling a cloud provider or enterprise to more easily allocate or select the appropriate capacity for any given service level. Decoupling also enables VSN storage pools to be easily migrated or load balanced among physical storage devices by moving the desired pools (or LUs) without having to readdress the pools (or LUs) based on the new host device. In other words, the shelf identifier and LUs move with the data instead of being tied to the physical device.

Reference is made throughout to storage pools and service pools. In this disclosure, a storage pool is a virtualized or logical portion of a physical storage device that is configured to have a specific storage configuration. In some embodiments, one physical storage device may include, host, or otherwise be partitioned into multiple different storage pools. In other embodiments, a storage pool may be provisioned or hosted by two or more physical storage devices such that the storage pool is physically distributed among separate devices or drives. In these other embodiments, the physical storage devices may be of the same type of physical storage device (e.g., a solid state drive (“SSD”)), a serial attached small computer system interface (“SCSI”) (“SAS”) drive, a near-line (“NL”)-SAS drive, a serial AT attachment (“ATA”) (“SATA”) drive, a Dynamic random-access memory (“DRAM”) drive, a synchronous dynamic random-access memory (“SDRAM” drive, etc.).

The specific storage configuration assigned to each storage pool specifies, for example, a RAID virtualization technique for storing data. As discussed below, any type of RAID level may be used including, for example, RAID0, RAID1, RAID2, RAID6, RAID10, RAID01, etc. The physical storage device type selected in conjunction with the data storage virtualization technique accordingly form a storage pool that uses a specific storage configuration.

In contrast to a storage pool, a service pool is a virtualized combination of logical slices or volumes from different storage pools of one or more VSNs. Each service pool is associated with or configured based on a data services configuration (e.g., service pool properties) that specifies how the service pool is to be constructed. The data services configuration may also specify how data is to be stored among the one or more logical slices or volumes (e.g., LUs). The data services configuration may also specify a file system type for managing data storage, client access information, and/or any other information or metadata that may be specified within a service-level agreement (“SLA”).

The example DSNs and VSNs are disclosed as operating using a Layer-2 Ethernet communication medium that incorporates ATA over Ethernet (“AoE”) as the network protocol for communication and block addressing. However, it should be appreciated that the DSN and/or the VSN may also be implemented using other protocols within Layer-2 including, for example, Address Resolution Protocol (“ARP”), Synchronous Data Link Control (“SDLC”), etc. Further, the DSN and the VSN may further be implemented using protocols of other layers, including, for example, Internet Protocol (“IP”) at the network layer, Transmission Control Protocol (“TCP”) at the transport layer, etc.

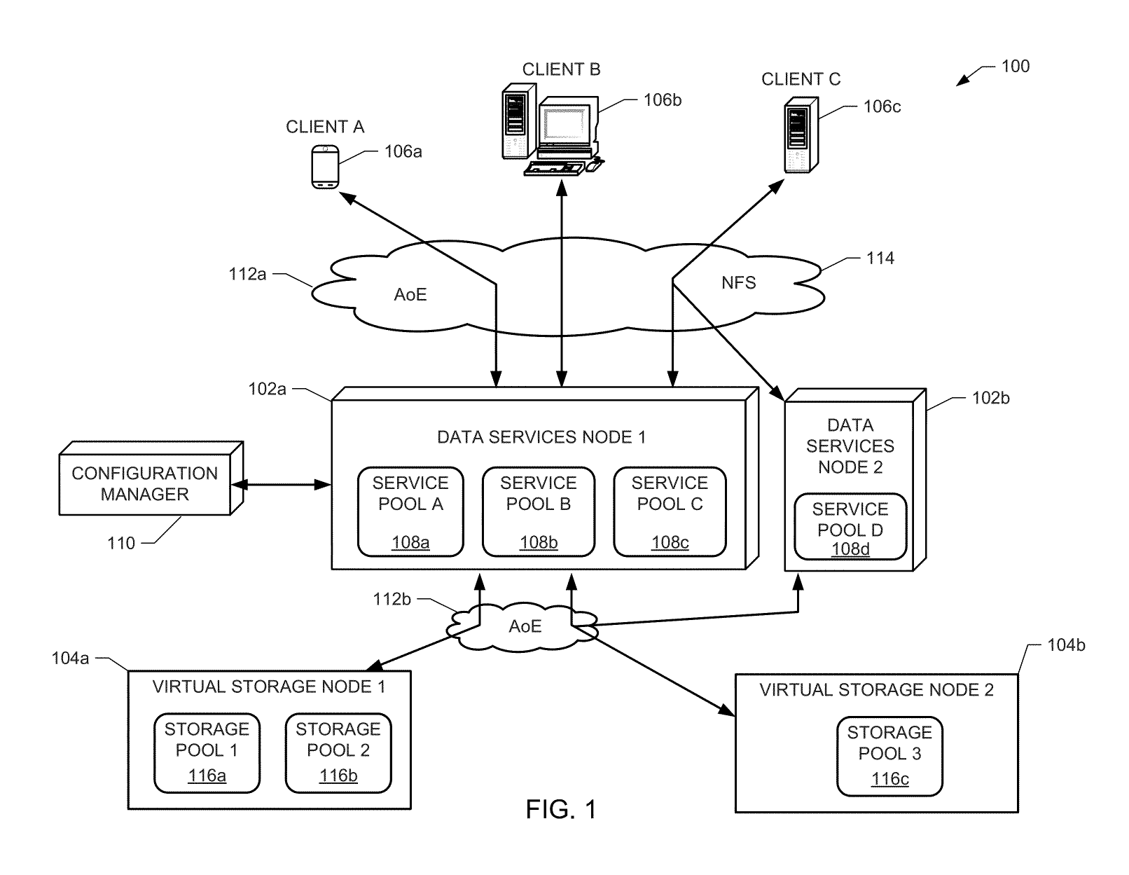

FIG. 1 shows a diagram of a multilayered file system environment 100 that includes DSNs 102 and VSNs 104, according to an example embodiment of the present disclosure. The example multilayered file system environment 100 may be implemented within any cloud storage environment, enterprise, etc. that enables client devices 106 to read, write, or otherwise access and store data to the VSNs 104. While the multilayered file system environment 100 shows the two DSNs 102a and 102b, it should be appreciated that other embodiments may include fewer DSNs or additional DSNs. Additionally, while the multilayered file system environment 100 shows the two VSNs 104a and 104b, other embodiments may include fewer VSNs or additional VSNs. Collectively, the DSNs 102a and 102b are referred to herein as the DSN 102 and the VSNs 104a, and 104b are referred to herein as the VSN 104.

The example DSN 102 includes service pools 108 that are separately configured according to respective data services characteristics. In this embodiment, the DSN 102a includes the service pools 108a, 108b, and 108c and the DSN 102b includes the service pool 108d. In other examples, either of the DSNs 102 may include additional or fewer service pools. The example DSNs 102 may be implemented on any type of server (e.g., a network file server), processor, etc. configured to manage a network file system.

The example service pools 108 are configured on the DSNs 102 via a configuration manager 110. In some embodiments, the configuration manager 110 may be included within the same server or device that hosts the DSNs 102. Alternatively, the configuration manager 110 may separate from and/or remotely located from the DSNs 102. The example configuration manager 110 is configured to receive, for example, a SLA from clients (e.g., clients associated with the client devices 106) and accordingly provision or create the service pools 108. In other embodiments, the configuration manager 110 may create the service pools 108 before any SLA is received. The created service pools 108 may be created to have popular or widely desired storage properties. The configuration manager 110 assigns clients to portions of requested service pools 108 responsive to the clients subscribing to a service provided by the configuration manager 110.

The example client devices 106 include computers, processors, laptops, smartphones, tablet computers, smart eyewear, smart watches, etc. that enable a client to read, write, subscribe, or otherwise access and manipulate data. In instances where the multiplayer file system environment 100 is implemented within a cloud computing service, the client devices 106 may be associated with different clients such that access to data is reserved only to client devices 106 authorized by the client. In instances where the multilayered file system environment 100 is implemented within an enterprise, the client devices 106 may be associated with individuals of the enterprise having varying levels of access to data. It should be appreciated that there is virtually no limitation as to the number of different clients that may be allowed access to the DSNs 102 and the VSNs 104.

In the illustrated example, the client devices 106 are communicatively coupled to the DSNs 102 via AoE 112. The DSNs 102 are configured to provide a network file system (“NFS”) 114 that is accessible to the client devices 106 via the AoE 112. Such a configuration provides security since only the client devices 106 that are part of the same local area network (“LAN”) or metropolitan area network (“MAN”) have access to the DSNs 102 via the AoE 112. In other words, the AoE 112 does not have an Internet Protocol (“IP”) address and is not accessibly by client devices outside of the local network. In instances where the DSNs 102 and the VSNs 104 are implemented within a cloud storage service, an access control device such as a network sever or a gateway may provide controlled access via Layer-2 to the DSNs 102 to enable client devices remote from the local network to access or store data. These client devices and/or network server may use, for example, a virtual LAN (“VLAN”) or other private secure tunnel to access the DSNs 102.

The example DSNs 102 are communicatively coupled to the VSNs 104 via the AoE 112b. The example AoE 112b may be part of the same or different network than the AoE 112 between the DSNs 102 and the client devices 106. The use of AoE 112b enables Ethernet addressing to be used between the service pools 108, storage pools 116, and individual portions of each of the storage pools (e.g., LUs). The use of AoE 112b also enables the communication of data between the DSN 102 and the VSN 104 through a secure LAN or other Ethernet-based network.

As illustrated in FIG. 1, the example VSN 104a includes storage pools 116a and 116b and the VSN 104b includes storage pool 116c. In other examples the VSNs 104 may include fewer or additional storage pools. Each of the storage pools 116 are virtualized over one or more physical storage devices and/or drives. The example storage pools 116 are individually configured based on storage configurations that specify how data is to be stored. Logical volumes are sliced or otherwise partitioned from each of the storage pools 116 and assigned to the service pools 108 to create multilayered file systems capable of providing one or many different storage configurations.

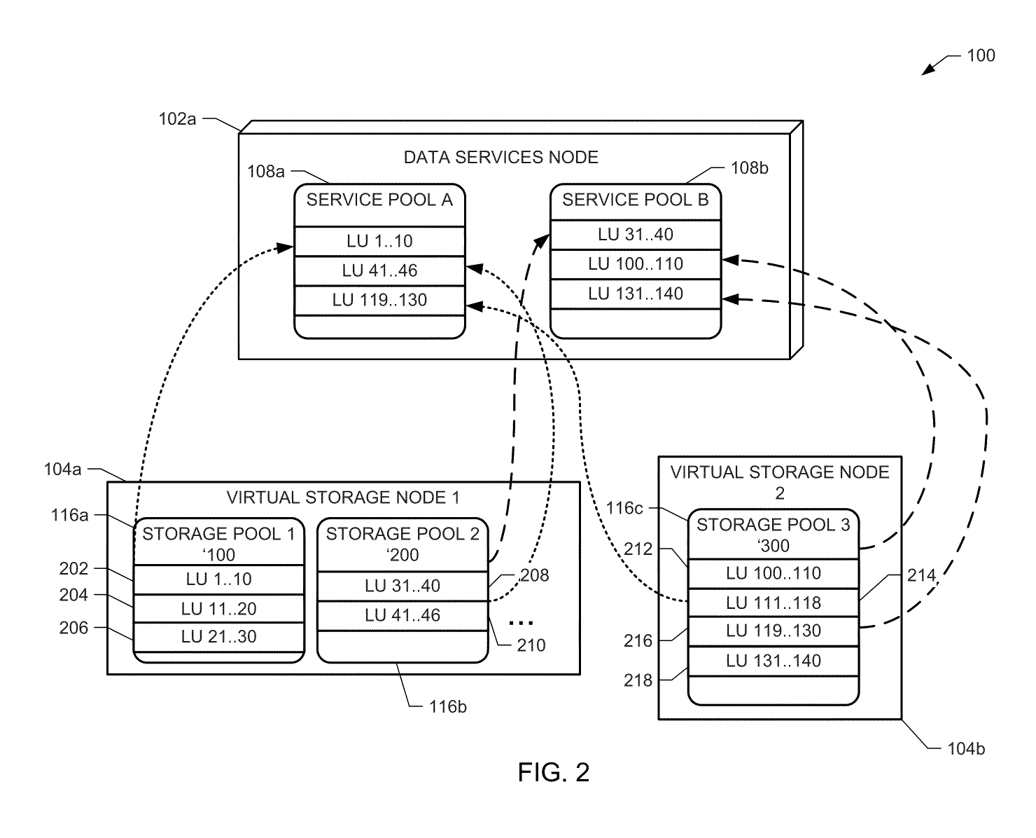

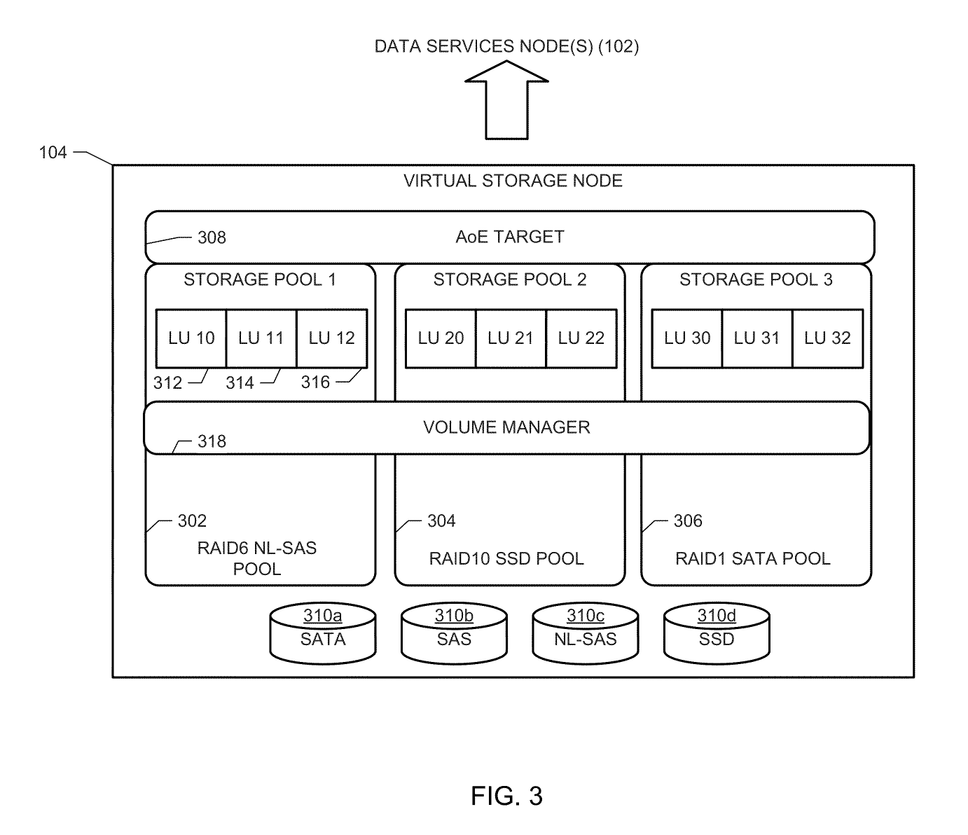

FIG. 2 shows a diagram of logical connections between the DSN 102a and the VSNs 104 of the multilayered file system environment 100 of FIG. 1, according to an example embodiment of the present disclosure. For brevity, only the service pools 108a and 108b from FIG. 1 are shown in FIG. 2. As discussed above, the VSNs 104 include storage pools 116, which are hosted or provisioned on physical storage devices or drives (as discussed in more detail in conjunction with FIG. 3). Each of the storage pools 116 are partitioned into individually addressable identifiable portions, shown in FIG. 2 as LUs. Further, each of the storage pools 116 may be assigned a shelf identifier. The DSN 102a is configured to access data stored at the VSN 104 using a Layer-2 messaging addressing scheme that uses the shelf identifier of the storage pools 116 and the LU.

For example, the storage pool 116a may be assigned a shelf identifier of 100, the storage pool 116b may be assigned a shelf identifier of 200, and the storage pool 116c may be assigned a shelf identifier of 300. Additionally, each of the storage pools 116 are partitioned into individually addressable identifiable portions that correspond to portions of the hosting physical storage device and/or drive allocated for that particular storage pool. The individually addressable identifiable portions are grouped into logical volumes that are assigned to one of the service pools 108 of the DSN 102a.

In the illustrated example of FIG. 2, the storage pool 116a includes groups or logical volumes including logical volume 202 of LUs 1 to 10, logical volume 204 of LUs 11 to 20, and logical volume 206 of LUs 21 to 30. The storage pool 116b includes logical volume 208 of LUs 31 to 40 and logical volume 210 of LUs 41 to 46. The storage pool 116c includes logical volume 212 of LUs 100 to 110, logical volume 214 of LUs 111 to 118, logical volume 216 of LUs 119 to 130, and logical volume 218 of LUs 131 to 140. As shown in FIG. 2, each logical volume 202 to 218 includes more than one LU. However, in other examples, a logical volume may include only one LU. Further, while each of the logical volumes 202 to 218 are shown as being included within one storage pool, in other examples, a logical volume may be provided across two or more storage pools.

It should be appreciated that in some embodiments individual LUs may be assigned to service pools 108 outside of logical volumes. For instance, the storage pool 116 may not be partitioned into logical volumes (or even have logical volumes), but instead partitioned only into the LUs. Such a configuration enables smaller and more customizable portions of storage space to be allocated.

Returning to FIG. 2, the example DSN 102a accesses a desired storage resource of the VSNs 104 using the self identifier of the storage pools 116 and the LU. For example, the DSN 102a may request data stored at LU 5 by sending a message using a Layer-2 addressing scheme that uses the shelf identifier 100 and the LU identifier 5. Such a configuration takes advantage of Layer-2 messaging without having to use addressing schemes of higher layers (e.g., IP address) to transmit messages between the DSN 102a and the VSN 104.

As shown in FIG. 2, some of the logical volumes 202 to 218 are assigned to one of the service pools 108 based on, for example, a data services configuration of the respective service pools and/or a SLA with a client. In this embodiment, the service pool 108a includes (or is assigned) the logical volume 202 (including LUs 1 to 10) from the storage pool 116a, the logical volume 210 (including LUs 41 to 46) from the storage pool 116b, and the logical volume 216 (including LUs 119 to 130) from the storage pool 116c. The service pools 108 of the DSN 102a are assigned the logical volumes 202 to 218 by storing the shelf identifier and the LU to the appropriate logical volume. The shelf identifier and LU may be stored to, for example, a list or data structure used by the service pools 108 to determine available logical volumes.

It should be appreciated that a service pool may include logical volumes from the same service pool. For example, the service pool 108b includes the logical volumes 212 and 218 from the storage pool 116c. Such a configuration may be used to expand the storage responses of a service pool by simply adding or assigning another logical volume without renumbering or affecting already provisioned or provided logical volumes. In the example of FIG. 2, the logical volume 218 may have been added after the logical volume 212 reached a threshold utilization or capacity. However, since the logical volumes include LUs that are individually identifiable and addressable, the logical volume 218 is able to be added to the service pool 108b without affecting the already provisioned logical volume 212, thereby enabling incremental unitary scaling without affecting data storage services already in place.

A benefit of the virtualization of the service pools 108 with the logical volumes 202 to 218 is that service pools may be constructed that incorporate storage systems with different storage configurations. For instance, the service pool 108 includes the logical volumes 202, 210, and 216 corresponding to respective storage pools 116a, 116b, and 116c. This enables the service pool 108a to use the different storage configurations as provided by the separate storage pools 116a, 116b, and 116c without having to implement entire dedicated storage pools only for the service pool 108a. Additionally, as storage service needs change, the configuration manager 110 may add logical volumes from other storage pools or remove logical volumes without affecting the other provisioned logical volumes. Such a configuration also enables relatively easy migration of data to other storage configurations by moving the logical volumes among the storage pools without changing the addressing used by the service pools.

### VSN Embodiment

FIG. 3 shows a diagram of an example virtual storage node 104, according to an example embodiment of the present disclosure. In this embodiment, the VSN 104 includes three different storage pools 302, 304, and 306 (similar in scope to storage pools 116a, 116b, and 116c of FIG. 1). The VSN 104 also includes an AoE target 308 (e.g., a Layer-2 Ethernet block storage target) that provides a Layer-2 interface for underlying physical storage devices 310. The AoE target 308 may also be configured to prevent multiple client devices 106 from accessing, overwriting, or otherwise interfering with each other. The AoE target 308 may also route incoming requests and/or data from the DSN 102 to the appropriate storage pool, logical volume, and/or LU.

As mentioned, the VSN 104 includes underlying physical storage devices 310 that are provisioned to host the storage pools 302 to 306. In the illustrated example, the physical storage devices 310 include a SATA drive 310a, a SAS drive 310b, an NL-SAS drive 310c, and an SSD drive 310d. Other embodiments may include additional types of physical storage devices and/or fewer types of physical storage devices. Further, while only one of each type of physical storage device 310 is shown, other examples can include a plurality of the same type of storage device or drive.

In the illustrated example of FIG. 3, each of the storage pools 302 to 306 are configured based on a different storage configuration. For instance, the storage pool 302 is configured to have a RAID6 storage configuration on the NL-SAS drive 310c, the storage pool 304 is configured to have a RAID10 storage configuration on the SSD drive 310d, and the storage pool 306 is configured to have a RAID1 configuration on the SATA drive 310a. It should be appreciated that the number of different storage configurations is virtually limitless. For instance, different standard, hybrid, and non-standard RAID levels may be used with any type of physical storage device and/or drive. In another instance, the storage pools 302, 304, and 306 may access different portions of the same drive.

As discussed above in conjunction with FIG. 2, the logical volumes may include one or more LUs. The example shown in FIG. 3 includes logical volumes each having one LU. For instance, a first logical volume 312 is associated with LU 10, a second logical volume 314 is associated with LU 11, and a third logical volume 316. Regarding the storage pool 302, each of the LUs are partitioned from a portion of the NL-SAS drive 310c configured with the RAID6 storage configuration. In other words, each of the LUs corresponds to a portion of the physical storage disk space with a specific storage configuration.

The example VSN 104 of FIG. 3 also includes a volume manager 318 configured to create each of the storage pools 302 to 306 and allocate space for the LUs on the physical storage devices 310. In some instances, the use of the volume manager 318 may assume processing-intensive tasks to free up resources at the DSN 102. These processing-intensive tasks can include, for example, protecting against data corruption, data compression, de-duplication and hash computations, remote replication, tier migration, integrity checking and automatic repair, shelf-level analytics, cache scaling, and/or providing snapshots of data. In some embodiments, the volume manager 318 may include a ZFS volume manager. For example, the volume manager 318 may be configured to move LUs and/or the storage pools 302 to 306 between the different physical storage devices 310 in the background without affecting a client. In another example, the VSN 104 may be connected to other VSNs via an IP, Ethernet, or storage network to enable snapshots of data to be transferred in the background without affecting a client.

As shown in FIG. 3, the volume manager 318 is configured to generate relatively small storage pools 302 to 306, each including a few LUs. The smaller storage pools enable, for example, faster re-slivering or allocating logical volumes to the DSN 102, faster data storage, and faster data access. The volume manager 318 also provides the multiple storage pools 302 to 306 for the VSN 104, which allows for the multi-tiring of storage using storage pools specific for particular types physical storage devices (e.g., SATA, SSD, etc.). The use of the storage pools 302 to 306 also enables the varying of storage configurations and redundancy policies (e.g., RAID-Z, single parity RAID, double-parity RAID, striping, mirroring, triple-mirroring, wide stripping, etc.). Further the use of the storage pools 302 to 306 in conjunction with the LUs enables faults to be isolated to relatively small domains without affecting other LUs, storage pools, and ultimately, other data/clients.

### DSN Embodiment

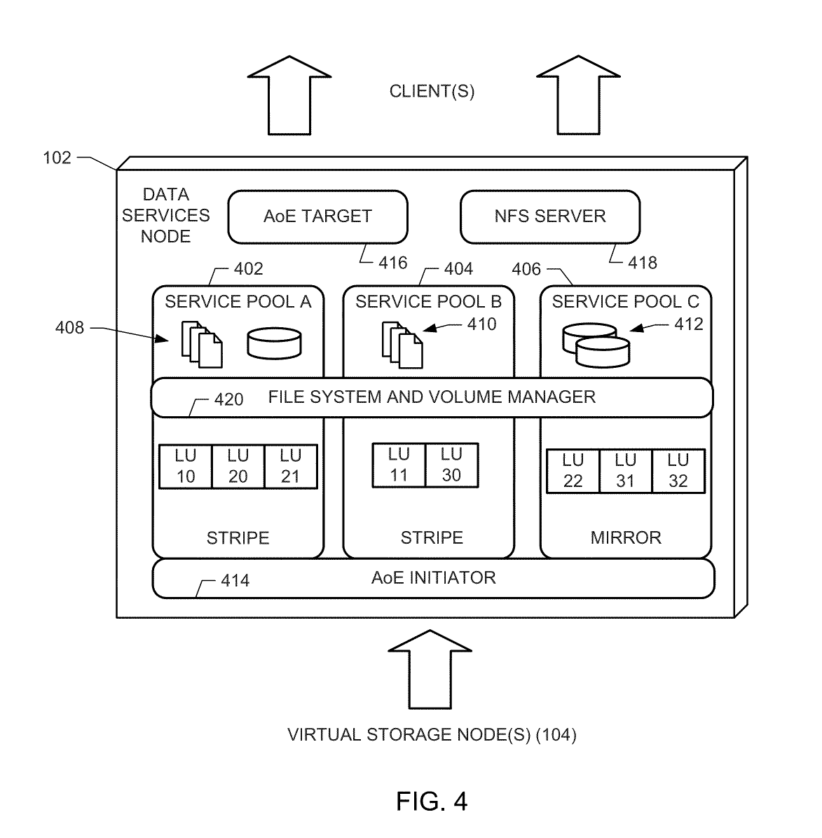

FIG. 4 shows a diagram of the example data services node 102 of FIG. 1, according to an example embodiment of the present disclosure. In this embodiment, the DSN 102 includes three different service pools 402, 404, and 406. Each of the service pools 402 to 406 have a data services configuration 408, 410, and 412 that specifies how data is to be stored (e.g., cache scaling) in addition to a file system structure and access requirements. In addition, each of the service pools 402 to 406 includes logical volumes, which in this embodiment are individual LUs.

As shown in FIG. 4, the service pool 402 includes the data services configuration 408 that specifies, for example, that stripe redundancy is to be used among and/or between LU 10 (of the storage pool 302 of FIG. 3) and LUs 20 and 21 (of the storage pool 304). Referencing back to the LUs 10, 20, and 21, the service pool 402 accordingly provides stripe data storage redundancy for data stored using the RAID6 storage configuration on the NL-SAS drive 310b and data stored using the RAID10 storage configuration on the SSD drive 310d. The configuration of the service pool 402 enables a storage platform or file system to be optimized for the input/output requirements of the client and optimized for caching. Further, the use of different types of drives within the same service pool enables, for example, primary cache scaling using one drive and secondary cache scaling using another drive.

Also shown in FIG. 4, the service pool 404 includes the data services configuration 410 that specifies, for example, that stripe redundancy is to be used among and/or between LU 11 (of the storage pool 302 of FIG. 3) and LU 30 (of the storage pool 306). Further, the service pool 406 includes the data services configuration 412 that specifies, for example, that mirror redundancy is to be used among and/or between LU 22 (of the storage pool 304 of FIG. 3) and LUs 31 and 32 (of the storage pool 306). It should be appreciated that the DSN 102 may include additional or fewer service pools, with each service pool including additional or fewer LUs. It should also be appreciated that while the LUs are shown within the service pools 402 to 406 of FIG. 4, as discussed in conjunction with FIG. 3, the LUs are instead provisioned within the storage pools of the VSN 104. The LUs shown at the service pools 402 to 406 of FIG. 4 are only references to the LUs at the VSN 104.

The example DSN 102 of FIG. 4 also includes an AoE initiator 414 configured to access the AoE target 308 at the VSN 104. The AoE initiator 414 accesses the LUs at the VSN 104 based on the specification as to which of the LUs are stored to which of the storage pools. As discussed, the addressing of the LU, in addition to the shelf identifier of the storage pools enables the AoE initiator 414 to relatively quickly detect and access LUs at the VSN 104.

The example DSN 102 further includes an AoE target 416 to provide a Layer-2 interface for the client devices 106. The AoE target 416 may also be configured to prevent multiple client devices 106 from accessing, overwriting, or otherwise interfering with each other. The AoE target 416 may further route incoming requests and/or data from the client devices 106 to the appropriate service pool 402 to 406, which is then routed to the appropriate LU.

The example DSN 102 also includes a NFS server 418 and file system and volume manager 420 configured to manage file systems used by the client devices 106. The NFS server 418 may host the file systems. The NFS server 418 may also host or operate the DSN 102. The example file system and volume manager 420 is configured to manage the provisioning and allocation of the service pools 402 to 406. The provisioning of the service pools 402 to 406 may include, for example, assignment of logical volumes and/or LUs. In particular, the file system and volume manager 420 may specify which LUs and/or logical volumes each of the service pools 402 to 406 may access or otherwise utilize. The use of the logical volumes enables additional LUs to be added to the service pools 402 to 406 by, for example, the file system and volume manager 420 without affecting the performance of already provisioned LUs or logical volumes.

### Flowcharts of the Example Processes

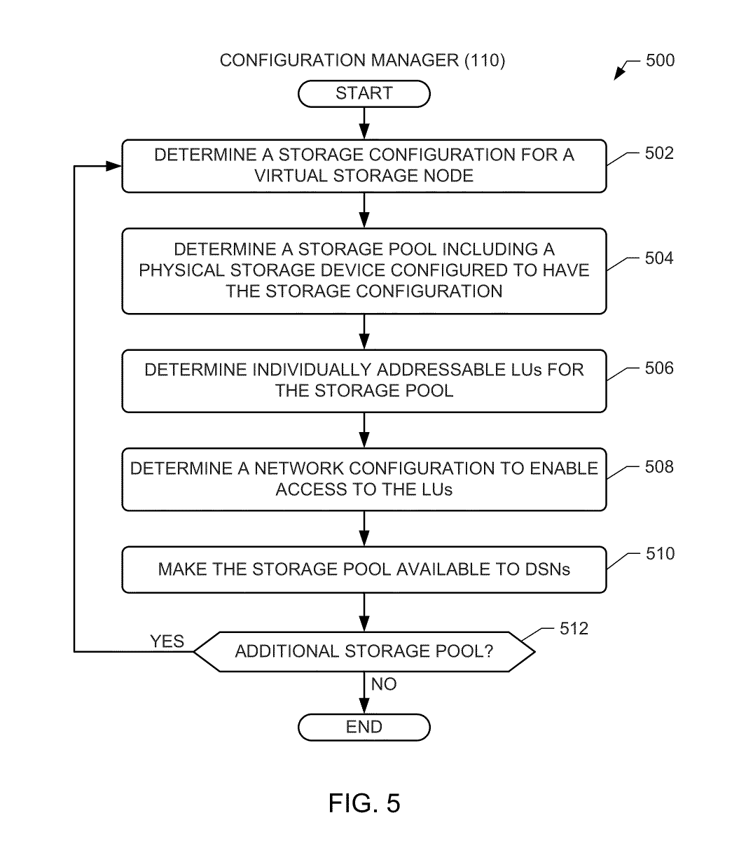

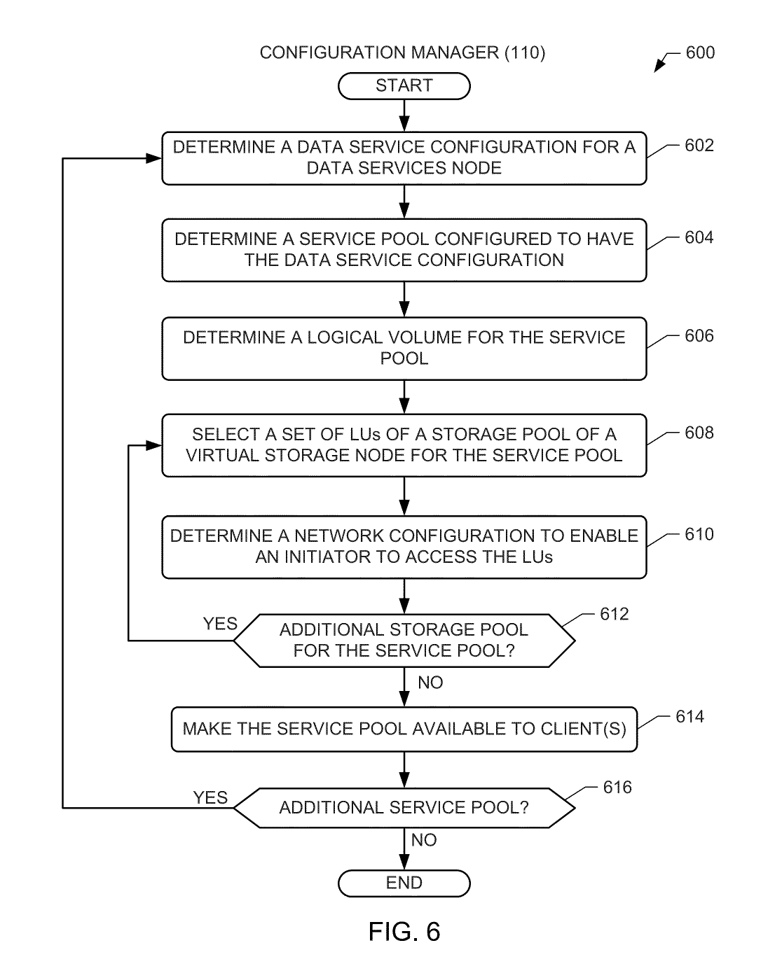

FIGS. 5 and 6 illustrate flow diagrams showing example procedures 500 and 600 to provision a VSN and a DSN, according to an example embodiment of the present disclosure. Although the procedures 500 and 600 are described with reference to the flow diagram illustrated in FIGS. 5 and 6, it should be appreciated that many other methods of performing the steps associated with the procedures 500 and 600 may be used. For example, the order of many of the blocks may be changed, certain blocks may be combined with other blocks, and many of the blocks described are optional. Further, the actions described in procedures 500 and 600 may be performed among multiple devices including, for example the configuration manager 110, the client devices 106, and/or the physical devices 310 of FIGS. 1 to 4.

The example procedure 500 of FIG. 5 begins when the configuration manager 110 determines a storage configuration for a VSN (e.g., the VSN 104) (block 502). The configuration manager 110 may determine the storage configuration based on information provided by a client via a SLA. Alternatively, the configuration manager 110 may determine the storage configuration based on popular or competitive storage configurations used by potential or future clients. The configuration manager 110 then determines a storage pool that includes one or more physical storage devices that are configured to have the specified storage configuration (block 504). The configuration manager 110 allocates or otherwise provisions space on the selected physical storage devices for the storage pool.

The example configuration manager 110 next determines or identifies individually addressable LUs (within a logical volume) for the storage pool (block 506). As discussed above, the LUs within the storage pool are logical representations of the underlying devices 310. In some instances, the configuration manager 110 may select or assign the addresses for each of the LUs. The configuration manager 110 also determines a network configuration to enable, for example, a DSN or a Layer-2 Ethernet block storage target to access the LUs (block 508). The network configuration may include a switching or routing table from a DSN to the LUs on the physical storage devices. The configuration manager 110 then makes the newly provisioned storage pool available for one or more DSNs (block 510). The configuration manager 110 may also determine if additional storage pools for the VSN are to be created (block 512). Conditioned on determining additional storage pools are to be created, the procedure 500 returns to block 502 where the configuration manager 110 determines another storage configuration for another storage pool. However, conditioned on determining no additional storage pools are needed, the procedure 500 ends.

Turning to FIG. 6, the example procedure 600 begins when the configuration manager 110 determines a data service configuration for a DSN (e.g., the DSN 102) (block 602). The data service configuration may be specified by, for example, a client via a SLA. Alternatively, the data service configuration may be based on popular or competitive data service configurations used by potential or future clients. The example configuration manager 110 determines a service pool configured to have the data service configuration (block 604).

The example configuration manager 110 also determines a logical volume (or a LU) for the service pool (block 606). Determining the logical volume includes identifying one more storage pools of a VSN that are to be used for the service pool. The configuration manager 110 selects or otherwise allocates a set of LUs of a logical volume within a VSN storage pool for the service pool (block 608). The configuration manager 110 also determines a network configuration to enable a Layer-2 Ethernet block storage initiator of the DSN to access the selected set of LUs (block 610). The network configuration may include, for example, provisioning the initiator of the DSN to access over a Lyer-2 communication medium the LUs logically located within the physical storage devices at the specified Layer-2 (or LU) address.

The example configuration manager 110 next determines if another storage pool is to be used for the service pool (block 612). If another storage pool is to be used, the example procedure 600 returns to block 608 where the configuration manager 110 selects another set of LUs of the other storage pool for the service pool. However, if no additional storage pools are needed, the example configuration manager 110 makes the service pool available to one or more clients (e.g., n+1 number of clients) (block 614). The configuration manager 110 also determines if another service pool is to be configured or provisioned for the DSN (block 616). Conditioned on determining the DSN is to include another service pool, the example procedure 600 returns to block 602 where the configuration manager 110 determines a data service configuration for the next service pool to be provisioned. The example procedure 600 may repeat steps 602 to 614 until, for example, n+1 number of service pools have been provisioned for the DSN. If no additional service pools are to be created, the example procedure 600 ends.

### Migration Embodiment

As mentioned above, data may be migrated between service pools of the same DSN or service pools of different DSNs. For example, data may be migrated from a first DSN to a second DSN that has more computing power or storage capacity. Data may also be migrated from a first DSN to a second DSN for load balancing when a service pool is operating at, for example, diminished efficiency and/or capacity. In an example embodiment, data may be migrated from the first service pool 108a of the DSN 102a to a new service pool of the DSN 102b. To migrate that data, the example configuration manager 110 of FIG. 1 configures the new service pool with the same data services configuration as the service pool 108a. The example configuration manager 110 also exports metadata from the service pool 108a including, for example, network system/block storage system/object file system information, access information, and any other SLA information. The configuration manager 110 imports this metadata into the newly created service pool. A Layer-2 Ethernet block storage initiator at the DSN 102b may use the metadata to discover the LUs assigned to the migrated data such that the LUs are now associated with the newly created service pool instead of the previous service pool 108a. At this point, a client may begin using the new service pool without any (or minimal) interruption in access to the data.

### Redistribution Embodiments

As disclosed above, the VSN 104 of FIGS. 1 to 3 is configured to have separate storage pools with a plurality of logical volumes, each with one or more LUs. The logical volumes and LUs are assigned identifiers to be compatible with a Layer-2 addressing scheme. The use of the logical volumes and LUs enables underlying drives and/or devices to be virtualized without having to readdress or reallocate any time a system change or migration occurs.

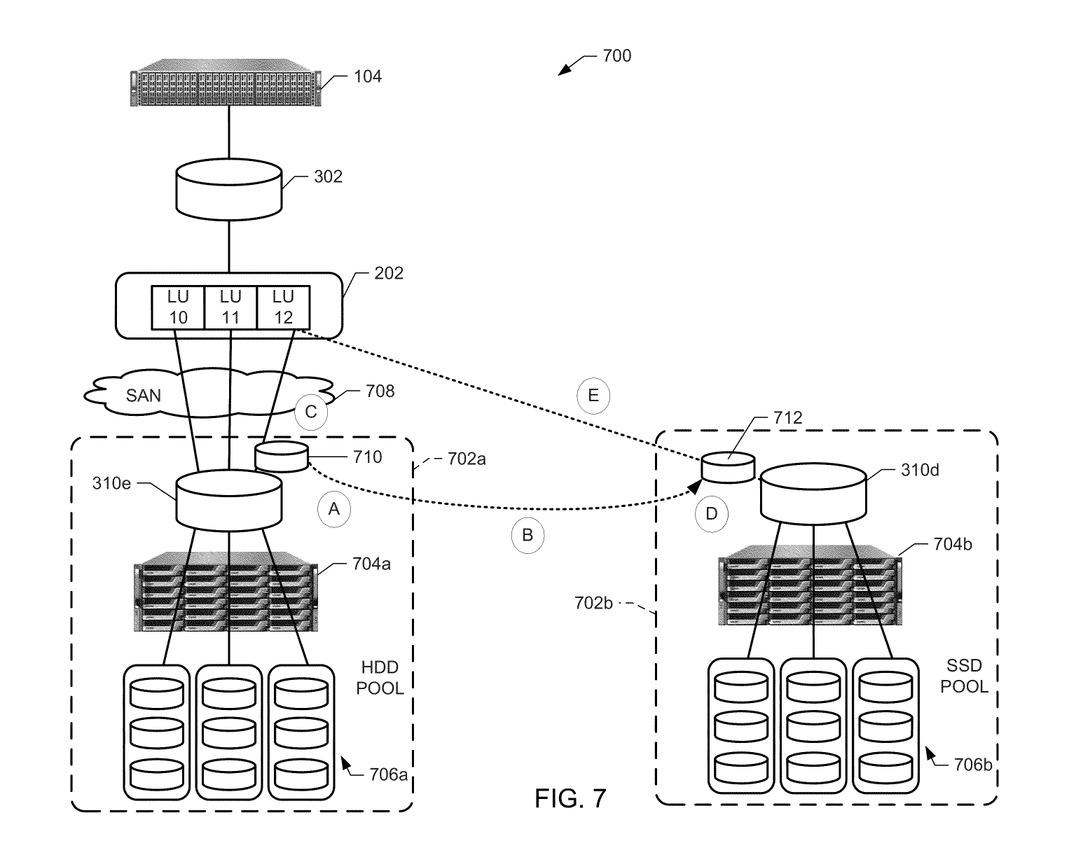

FIG. 7 shows a diagram of a procedure 700 to redistribute a LU among physical storage pools 702 within the VSN 104 of FIGS. 1 to 3, according to an example embodiment of the present disclosure. As discussed above, a storage pool includes underlying pools of physical drives or devices 310. The storage pools and physical drives may be partitioned or organized into a two-tier architecture or system for the VSN 104. For instance, in a top tier, the VSN 104 includes the storage pool 302 (among other storage pools not shown), which includes the logical volume 202 having LUs 10, 11, and 12 (e.g., virtual representations of LUs assigned or allocated to the underlying devices 310). As illustrated, in a lower tier, the LUs are assigned portions of one or more devices 310 (e.g., the HDD device 310e) in a physical storage pool 702. The devices 310 include redundant physical storage nodes 704 each having at least one redundant physical storage group 706 with one or more physical drives. The top tier is connected to the lower tier via an Ethernet storage area network (“SAN”) 708.

The redistribution of LUs between the physical storage pools 702 associated with the storage pool 302 enables a provider to offer non-disruptive data storage services. For instance, a storage pool may be disruption free for changes to performance characteristics of a physical storage pool. In particular, a storage pool may be disruption free (for clients and other end users) during a data migration from an HDD pool 702a to an SSD pool 702b, as illustrated in FIG. 7. In another instance, a storage pool may remain disruption free for refreshes to physical storage node hardware (e.g., devices 310, 704, and 706). In yet another instance, a storage pool may remain disruption free for rebalancing of allocated storage pool storage in the event of an expansion to the physical storage node 704 to relieve hot-spot contention. Further, the use of the VSN 104 to redistribute Ethernet LUs enables re-striping storage pool contents in the event of excess fragmentation of physical storage pools due to a high rate of over-writes and/or deletes in the absence of a file system trim command (e.g., TRIM) and/or an SCSI UNMAP function.

Returning to FIG. 7, the example procedure 700 is configured to redistribute the LU 12 of the logical volume 202 within the storage pool 302 from the HDD pool 702a to the SSD pool 702b. It should be appreciated that the virtual representation of the LU 12 within the logical volume 202 remains the same throughout the migration. First, at Event A, a logical representation 710 of the LU 12 is determined within the HDD pool 702a (e.g., using ZFS to acquire a snapshot of LU 12). At event B, the logical representation 710 is replicated peer-to-peer between the pools 702 as logical representation 712 (e.g., using ZFS to send the logical representation 710 of the LU to the SSD pool 702b). In this embodiment, one baseline transfer of the LU 12 performs the majority of the transfer using, for example ZFS send and receive commands. The transfer of the LU 12 continues during Event B as updates are performed (as required) based on bandwidth between the pools 702 and/or change deltas.

At Event C, after the change deltas become relatively small, a cut-over operation is performed where the logical representation 710 of the LU 12 is taken offline and one last update is performed. At Event D, the Ethernet LU identifier is transferred from the logical representation 710 to the logical representation 712. At Event E, the logical representation 712 is placed online such that the virtual representation of the LU 12 within the logical volume 202 of the storage pool 302 instantly begins using the logical representation 712 of the LU 12 including the corresponding portions of the drive 310d.

It should be appreciated that the above described Events A to E may be repeated until all virtual representations of designated LUs have been transferred. In some embodiments, the Events A to E may operate simultaneously for different LUs to the same destination physical storage pool and/or different destination physical storage pools. Additionally, in some embodiments, the transfer of the logical representation 710 of the LU 12 may be across the SAN 708. Alternatively, in other embodiments, the transfer of the logical representation 710 of the LU 12 is performed locally between controllers of the physical storage pools 702 instead of through the SAN 708.

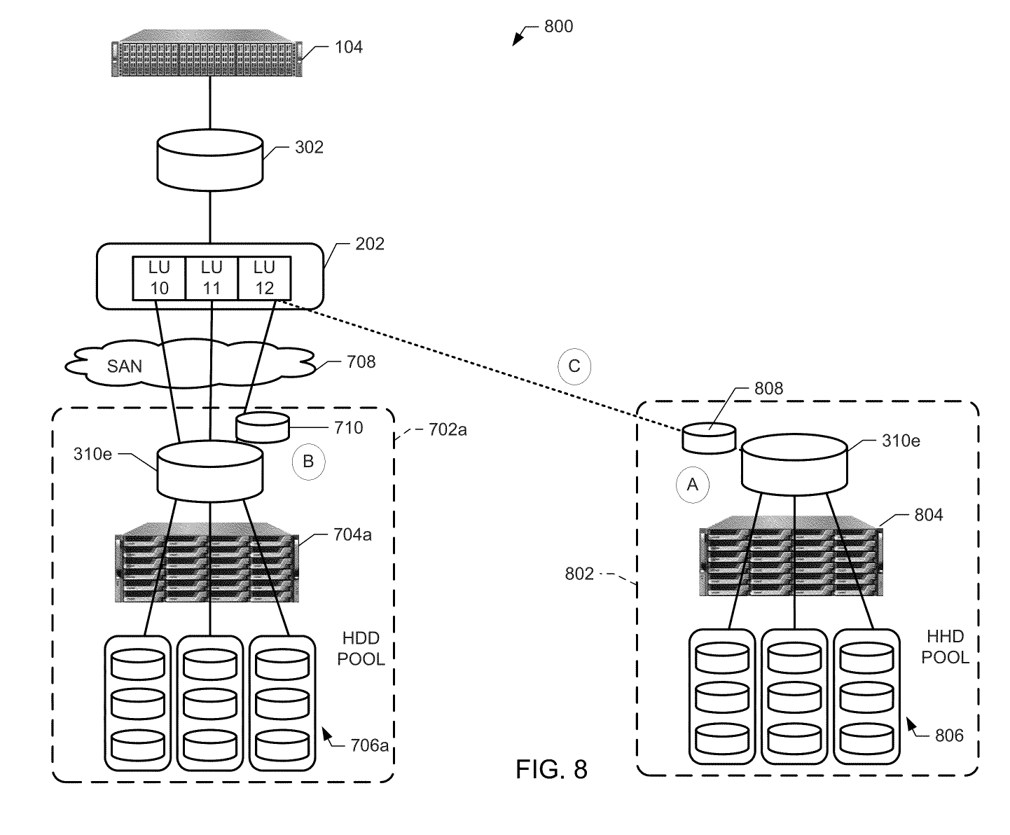

FIG. 8 shows a diagram of an example procedure 800 to re-silver or re-allocate a LU among physical storage pools 702 and 802 within the VSN 104 of FIGS. 1 to 3, according to an example embodiment of the present disclosure. In this embodiment, the physical storage pool 800 is also an HDD pool and includes redundant physical storage nodes 804 and redundant physical storage groups 806. The procedure 800 begins at Event A with the provisioning of a new logical representation 808 of the Ethernet LU 12. At Event B, after the VSN 104 can access the new logical representation 808, a replace command (e.g., a zpool replace command) is issued to re-silver the old logical representation 710 of the Ethernet LU 12 to the new logical representation 808. At Event C, only data blocks accessible or viewable by the storage pool 302 are read from the old logical representation 710 and written to the new logical representation 808.

Similar to the example discussed in conjunction with FIG. 7, the transfer of the logical representation 710 of the LU 12 to the physical storage pool 802 may be across the SAN 708. However, in other embodiments, the transfer of the logical representation 710 of the LU 12 is performed locally between controllers of the physical storage pools 702 and 802 instead of through the SAN 708. In some embodiments, the LU 12 may be re-silvered within the same HHD pool 702. Re-silvering within the same physical storage pool 702 results in improved migration (or re-silvering) efficiency by avoiding SAN data traffic. This configuration accordingly enables the SAN 708 to be dedicated to application data, thereby improving SAN efficiency.

### Decentralization Embodiments

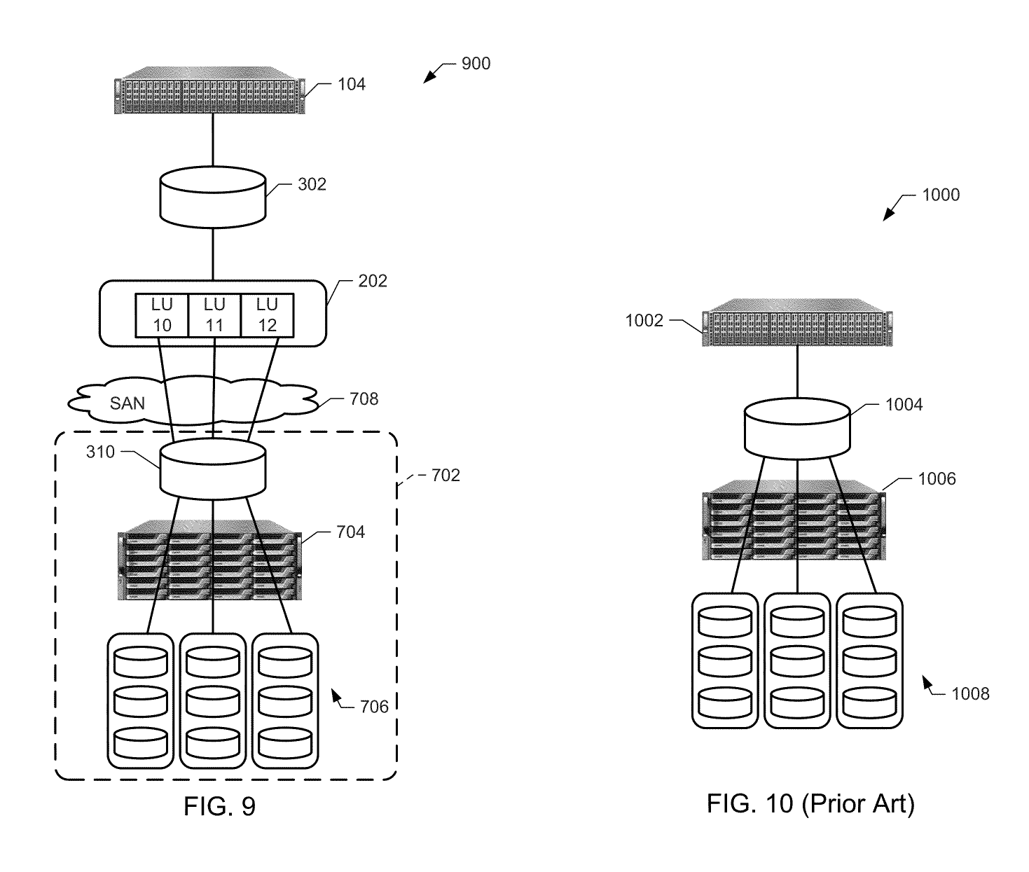

As discussed above in conjunction with FIGS. 7 and 8, the VSN 104 may be partitioned into two or more tiers to distribute storage functionality and optimize bandwidth. FIG. 9 shows a diagram of a two-tier architecture 900 for the example VSN 104 of FIGS. 1 to 3, 7, and 8, according to an example embodiment of the present disclosure. As discussed in conjunction with FIGS. 7 and 8, the two-tier architecture 900 includes a first tier with the VSN 104, the storage pool 302, and the logical volume 202 with LUs 10, 11 and 12. A second tier of the two-tier architecture 900 includes the physical storage pool 702, which includes the device 310, the physical storage nodes 704, and the physical storage groups 706. The first tier is a virtualization of the second tier, which enables migration/readdressing/reallocation/re-slivering/etc. of the devices within the physical storage pool 702 without apparent downtime to an end user or client.

In contrast to FIG. 9, FIG. 10 shows a diagram of a known single tier ZFS architecture 1000 that includes a storage node 1002 and a storage pool 1004. The single tier architecture 1000 also includes a physical storage node 1006 and a physical storage group 1008. It should be appreciated that unlike the two-tier architecture 900, the known single tier architecture 1000 does not include a virtualization tier including a VSN, logical volumes, or LUs. In this known single tier architecture 1000, all of the intelligence is placed into the storage node 1002 using directly attached disks or devices (e.g., the physical storage group 1008). In comparison, the example two-tier architecture 900 instead enables ZFS to be decentralized by using the physical storage node 704, which host ZFS and exposes LUs to a virtual storage controller (e.g., the VSN 104) that also operates ZFS. Such a decentralized configuration enables work, processes, or features to be distributed between the VSN 104 and the underlying physical storage node 704 (or more generally, the physical storage pool 702).

It should be appreciated that the decentralization of two-tier architecture 900 enables simplification of the functions performed by each of the tiers. For example, the VSN 104 may process a dynamic stripe (i.e., RAID0), which is backed by many physical storage nodes 704. This enables the VSN 104 to have relatively large storage pools and/or physical storage pools while eliminating the need for many storage pools and/or physical storage pools if many pools are not needed to differentiate classes of physical storage (e.g., SSD and HDD drives). The following sections describe offloading differences between the example two-tier architecture 900 and the known single tier ZFS architecture 1000.

### A. Raid Calculation Embodiment

In the known single tier ZFS architecture 1000 the storage node 1002 is configured to write data/metadata and perform all the RAID calculations for the storage pool 1004. As additional storage is added to the architecture 1000, the burden on the storage node 1002 becomes relatively high because significantly more calculations and writes have to be performed within a reasonable time period. In contrast, the VSN 104 of the example two-tier architecture 900 is configured to write data and metadata without parity information in a parallel round-robin operation across all available LUs within the storage pool 302. The physical storage node 704 is configured to write all the RAID parity information required by the drive 310 (or more generally the physical storage pool 702). The addition of storage to the two-tier architecture 900 does not become more burdensome for the VSN 104 because physical storage nodes 704 are also added to handle the additional RAID calculations.

### B. Drive Rebuild Embodiment

When a device within the physical storage group 1008 fails in the known single tier ZFS architecture 1000 the entire storage pool 1004 is affected and may be taken offline. The chances of a failure to the storage pool 1004 become more likely as more drives are added to the physical storage group 1008 or the storage pool 1004. This is especially true if more drives fail during a rebuild, which may cause a re-silvering process at the storage pool 1004 to restart, thereby increasing the amount of time data is unavailable to a client.

In contrast, the VSN 104 of the example two-tier architecture 900 is configured to mitigate failures to underlying drives within the physical storage group 706. For instance, when an SSD or HDD fails in the physical storage group 706, the storage pool 302 is not affected because re-silvering occurs primarily within the physical storage node 704 of the physical storage pool 702 and/or the device 310. As can be appreciated, the addition of more physical storage nodes does not affect re-silvering on other physical storage nodes, thereby improving drive rebuild reliability.

### C. Compression Embodiment

In the known single tier ZFS architecture 1000 of FIG. 10 only one compression algorithm may be chosen for the storage node 1002. As mentioned above, the storage node 1002 includes all the intelligence thereby preventing other algorithms from being used at the storage pool 1004 or the physical storage nodes 1006. In comparison, the example two-tier architecture 900 of FIG. 9 is configured to distribute multiple compression algorithms to different tiers since intelligence is distributed. For example, the VSN 104 may use a fast compression algorithm while the physical storage node 704 is configured to use the best algorithm for space savings. If Ethernet bandwidth becomes scarce or limited, the VSN 104 may be configured to use a balanced compression algorithm to increase throughput while maintaining efficiency. Such a distribution of compression algorithms enables the example two-tier architecture 900 to transmit and store data more efficiently based on the strengths and dynamics of the VSN 104 and the physical storage nodes 704 and bandwidth available in the storage system.

### D. Deduplication Embodiment

Deduplication of data means that only a single instance of each unique data block is stored in a storage system. A ZFS deduplication system may store references to the unique data blocks in memory. In the known single tier ZFS architecture 1000 the storage node 1002 is configured to perform all deduplication operations. As such, it is generally difficult to grow or increase capacity at the storage pool 1004 in a predictable manner. At a large scale, the storage node 1002 eventually runs out of available resources.

The two-tier architecture 900, in contrast, offloads the entire deduplication processing to the physical storage nodes 704. It should be appreciated that each physical storage node 704 has a record of storage parameters of the underlying physical storage group 706 because it is not possible to increase the node 704 beyond its fixed physical boundaries. The storage parameters include, for example, an amount of CPU, memory, and capacity of the physical storage group 706. Such a decentralized configuration enables additional physical storage nodes 704 to be added without affecting LU assignment within the storage pool 302. The addition of the nodes 704 (including physical storage groups) does not burden deduplication since each node is responsible for its own deduplication of the underlying physical storage group 706.

### E. Data Integrity Embodiment

In the known single tier ZFS architecture 1000 of FIG. 10, data integrity verification or scrubbing may only occur at the storage pool 1004. As the storage pool 1004 grows, scrubbing may become problematic because any such data integrity or scrubbing process may run for weeks and severely degrade system performance. The storage pool 302 of the example two-tier architecture 900 by contrast does not need to be scrubbed because there is no redundancy information stored. Scrubbing instead is isolated to the devices 310 and/or the physical storage pool 702. As such, scrubbing may be run in isolation within one physical storage pool 702 without affecting other physical storage pools. Multiple physical storage pools 702 may be run in sequence if the storage pool 302 spans or includes multiple pools 702 to prevent system-wide performance degradation during a scrub process.

### F. Caching Embodiment

Cache (read) and log (write) devices may only be added to the storage pool 1004 in the known single tier ZFS architecture 1000. In contrast to the single tier ZFS architecture 1000, the example two-tier architecture 900 enables cache and log devices to be added to both the storage pool 302 and the physical storage pool 702 (or devices 310). This decentralization of cache and log devices improves performance by keeping data cached and logged in proximity to the slowest component in the storage system, namely the HDDs and SSD drives within the physical storage group 706. This decentralized configuration also enables data to be cached in proximity to the VSN 104. As more physical storage pools 702 (and/or devices 310) with more cache and log devices are added to the storage pool 302, larger working sets may be cached, thereby improving overall system performance.

### G. Replication Embodiment

In the known single tier ZFS architecture 1000 of FIG. 10 replication is only possible between storage nodes 1002 as a result of static addressing of the underlying drives within the physical storage group 1008. The example two-tier architecture 900 in contrast only has to replicate the physical storage pool 702 or device 310. The storage pool 302 and logical volumes 202 remain unchanged since the addressing is virtualized, which is a benefit of using the two-tier storage architecture. Accordingly, only the physical storage pool 702 needs to be replicated to gain access to the storage pool 302 from either the VSN 104 or another arbitrary VSN (not shown) that is given access to the LUs. In the example two-tier architecture 900 replication may propagate across out-of band networks and not interfere with traffic on the SAN 708.

An orchestration mechanism may be used between the VSN 104 and the physical storage node 704 to facilitate the consistency of the storage pool 302 during replication. The orchestration mechanism may be configured to ensure application integrity before replication begins. The orchestration mechanism may also enable replication to occur in parallel to multiple destination physical storage pools.

### H. Pool Migration Embodiment

Generally, limitations in physical storage connectivity limit flexible pool migration in the known single tier ZFS architecture 1000. In contrast, the example two-tier architecture 900 enables the storage pool 302 to be migrated from a retired VSN (e.g., the VSN 104) to a new VSN (not shown) by just connecting the new VSN to the Ethernet SAN 708. Once the new VSN is connected, the storage pool 302 may be imported. Any cache or log devices local to the retired VSN 104 may be removed from the storage pool 302 before the migration and moved physically to the new VSN. Alternatively, new cache and log devices may be added to the new VSN. This decentralized migration may be automated by orchestration software.

### CONCLUSION

It will be appreciated that all of the disclosed methods and procedures described herein can be implemented using one or more computer programs or components. These components may be provided as a series of computer instructions on any computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An apparatus for providing hierarchical data storage comprising:
a virtual storage node including:
a first storage pool including a first physical storage device, the first storage pool configured to have a first storage configuration and partitioned into individually identifiable portions,
a second storage pool including a second physical storage device, the second storage pool configured to have a second storage configuration and partitioned into individually identifiable portions,
a Layer-2 Ethernet block storage target, and
a file system and volume manager configured to manage the storage of data at the first physical storage device and the second physical storage device; and
a data services node including:
a first service pool configured to have at least one striped or mirrored logical volume from the virtual storage node, the at least one logical volume including at least a first set of identifiable portions from the first storage pool and a first set of identifiable portions from the second storage pool,
a second service pool configured to have at least one striped or mirrored second logical volume from the virtual storage node, the at least one second logical volume including a second set of identifiable portions from the first storage pool and a second set of identifiable portions from the second storage pool,
an Layer-2 Ethernet block storage initiator communicatively coupled to the Layer-2 Ethernet block storage target of the virtual storage node, and
a file system and volume manager configured to manage the storage of data at the first service pool and the second service pool.

2. The apparatus of claim 1, wherein the virtual storage node includes n+1 number of storage pools, each of the n+1 storage pools including at least one physical storage device, being configured to have a specified storage configuration, and partitioned into individually identifiable portions.

3. The apparatus of claim 1, wherein the first storage configuration and the second storage configuration includes at least one of a standard redundant array of independent disks (“RAID”) level, a hybrid RAID level and a non-standard RAID level.

4. The apparatus of claim 1, wherein the first physical device and the second physical device includes at least one of a solid state drive (“SSD”), a serial attached small computer system interface (“SCSI”) (“SAS”) drive, a near-line (“NL”)-SAS drive, a serial AT attachment (“ATA”) (“SATA”) drive, and a non-volatile storage drive.

5. The apparatus of claim 1, wherein the data services node further includes a network storage protocol server configured to host the first service pool and the second service pool.

6. The apparatus of claim 1, wherein the network storage protocol server includes a file storage system that includes at least one of a network file system (“NFS”) and a Common Internet File System (“CIFS”), a block storage system that includes at least on of Internet Small Computer System Interface (“iSCSI”) and AoE, or an object file system that includes at least one of Amazon S3 and Openstack Swift.

7. The apparatus of claim 1, wherein the individually identifiable portions are logical unit numbers (“LUs”) for at least one of block storage, shares for file storage, and objects for object storage.

8. The apparatus of claim 1, wherein the Layer-2 Ethernet block storage initiator is communicatively coupled to the Layer-2 Ethernet block storage target.

9. An apparatus for providing hierarchical data storage comprising:
a virtual storage node including a first physical storage device including:
a first storage pool configured to have a first storage configuration and partitioned into individually addressable LUs, and
a second storage pool configured to have a second storage configuration and partitioned into individually addressable LUs; and
a data services node including a service pool configured to have a data services configuration specifying how data is stored to logical volumes from the virtual storage node, the logical volumes including at least a first set of LUs from the first storage pool and a second set of LUs from the second storage pool,
wherein the first set of LUs from the first storage pool and the second of LUs from the second storage pool are accessible by the data services node via a communication medium that connects the virtual storage node with the data services node and uses the individual addresses of the LUs as target addresses.

10. The apparatus of claim 9, wherein the service pool is a first service pool and the data services node further includes a second service pool configured to have a second data services configuration specifying how data is stored to a second logical volume from the virtual storage node, the second logical volume including at least a third set of LUs from the first storage pool and fourth of LUs from the second storage pool.

11. The apparatus of claim 9, wherein the first storage configuration enables one or more LUs from the first storage pool to be combined using a technique including at least one of striping, mirroring, and RAID and the second storage configuration enables one or more LUs from the second storage pool to be combined using a technique including at least one of striping, mirroring, and RAID.

12. The apparatus of claim 9, wherein the communication medium is a Layer-2 Ethernet medium.

13. The apparatus of claim 9, wherein a first portion of the first service pool is provisioned for a first client and a second portion of the first service pool is provisioned for a second client.

14. The apparatus of claim 9, wherein the first service pool is provisioned for n+1 number of clients.

15. The apparatus of claim 9, wherein the first physical storage device includes n+1 number of service pools.

16. The apparatus of claim 9, wherein the data services configuration includes at least one of a specified file system and an indication of authorized clients.

17. A method for provisioning hierarchical data storage comprising:
provisioning a virtual storage node by:
determining a storage pool configured to have a storage configuration hosted by a physical storage device,
determining individually addressable LUs for the storage pool associated with different portions of the physical storage device, and
determining a network configuration to enable a block storage target to access the LUs; and
provisioning a data services node in a server by:
determining a first service pool configured to have a first data services configuration specifying how data is stored to a logical volume from the virtual storage node,
determining a second service pool configured to have a second data services configuration specifying how data is stored to the logical volume from the virtual storage node,
determining n+1 number of service pools configured to have a specified data services configuration specifying how data is stored to the logical volume from the virtual storage node,
determining the network configuration to enable an initiator to access the LUs,
selecting a first set of LUs among the logical volume of the storage pool of the virtual storage node for the first service pool,
selecting a second set of LUs among the logical volume of the storage pool of the virtual storage node for the second service pool, and
selecting a n+1 number of sets of LUs among the logical volume of the storage pool of the virtual storage node for the respective n+1 service pools; and
making the first service pool, the second service pool, and the n+1 service pools available to at least one client.

18. The method of claim 17, wherein the first set of LUs for the first service pool are selected by assigning addresses of the selected first set of LUs to the first service pool and the second set of LUs for the second service pool are selected by assigning addresses of the selected second set of LUs to the second service pool.

19. The method of claim 17, further comprising:
adding a second storage device to the virtual storage node having the storage configuration;
determining individually addressable LUs for the storage pool from the second storage device;
determining the network configuration to enable the block storage target to access the LUs; and
selecting a set of LUs from the second storage pool of the virtual storage node for the first service pool.

20. The method of claim 19, wherein the second storage device is added responsive to determining the virtual storage node is operating at diminished efficiency.

21. The method of claim 19, wherein the second storage device is added responsive to determining the storage device is approaching capacity.

22. The method of claim 19, further comprising removing the second storage device responsive to determining the second storage device is operating at diminished efficiency.
